(19) United States
(12) Patent Application Publication
(10) Pub. No.: US 2010/0321516 A1
(43) Pub. Date: Dec. 23, 2010

(54) DIGITAL CAMERA APPARATUS AND RECORDING MEDIUM FOR RECORDING COMPUTER PROGRAM FOR SUCH APPARATUS

(75) Inventors: Motoyuki Kashiwagi, Tokyo (JP); Hiroyuki Nakata, Tokyo (JP); Takashi Itoh, Tokyo (JP)

Correspondence Address: HOLTZ, HOLTZ, GOODMAN & CHICK PC, 220 Fifth Avenue, 16TH Floor, NEW YORK, NY, 10001-7708, US

(73) Assignee: Casio Computer Co., Ltd., Tokyo (JP)

(21) Appl. No.: 12/794,930

(22) Filed: Jun. 7, 2010

(30) Foreign Application Priority Data
Jun. 19, 2009 (JP) 2009-146500

(51) Int. Cl. H04N 5/228

(52) U.S. Cl. 348/222.1; 348/E05.031

(57) ABSTRACT

In a digital camera apparatus, drive mode of CCD is set to AF mode in AF controlling operation (at step S4), and is set to a capture mode in a shooting operation (at step S12). AFE for processing an image signal output from CCD is held in a halt state during a rapid sweeping period, in which unnecessary charge that is not used as pixel information is discharged (at steps S5, S9, S13, S17), whereby power consumed by AFE in a shooting mode is reduced.

### BACKGROUND OF THE INVENTION

1. Field of the Invention

The present invention relates to a digital camera apparatus and a recording medium for recording a computer program for such apparatus.

2. Description of the Related Art

Various techniques that reduce power consumption in image pick-up apparatuses have been proposed as stated below. Patent document 1 (Japanese Patent No. 2008-160369 A, “Image pick-up apparatus”) proposes a technique that stops generating a timing signal indicating a timing of sample hold in the correlated double sampling process, stopping performing the correlated double sampling process. Patent document 2 (Japanese Patent No 2007-104278 A, “Image pick-up apparatus”) proposes a technique, in which when an object is shot in along exposure time, AFE (Analog Front End) including CDS (Correlated Double Sampling), PGA (Programmable Gain Amplifier) and ADC (Analog-to-Digital Converter) is held in a halt state before an image signal is obtained in such long exposure time and output from a solid state image device. Further, Patent document 3 (Japanese Patent No. 2006-81048 A “Image pick-up apparatus”) proposes a technique that stops operation of AFE during a period other than a period in which an image signal is read when images are repeatedly shot.

Although the above techniques can reduce power consumption in the image pick-up apparatuses during the image pick-up operation, a problem that cannot reduce power consumption to the customer's full satisfaction is left, even if these conventional techniques are employed in digital camera apparatuses.

### SUMMARY OF THE INVENTION

According to one aspect of the invention, there is provided a digital camera apparatus, which comprises a solid state image pick-up device for photoelectric-converting an optical image of an object into an analog signal representing an object image of the object, a signal processing unit for as performing an analog signal process on the analog signal converted by the solid state image pick-up device, and a stop controlling unit for stopping the signal processing unit from performing the analog signal process on the analog signal which is composed of predetermined charge that is not used as pixel information, during a rapid sweeping period, in which the analog signal which is composed of the predetermined charge that is not used as pixel information, is discharged more rapidly from the solid state image pick-up device than the analog signal which is composed of charge that is used as pixel information.

According to another aspect of the invention, there is provided a computer readable recording medium to be mounted on a digital camera apparatus, wherein the digital camera apparatus is provided with a computer, a solid state image pick-up device for photoelectric-converting an optical image of an object into an analog signal representing an object image of the object, and a signal processing unit for performing an analog signal process on the analog signal converted by the solid state image pick-up device, the recording medium having recorded thereon a computer program when executed to make the computer function as a stop controlling unit for stopping the signal processing unit from performing the analog signal process on the analog signal which is composed of predetermined charge that is not used as pixel information, during a rapid sweeping period, in which the analog signal which is composed of the predetermined charge that is not used as pixel information, is discharged more rapidly from the solid state image pick-up device than the analog signal which is composed of charge that is used as pixel information.

### BRIEF DESCRIPTION OF THE DRAWINGS

FIG. 1 is a block diagram of a hardware configuration of a digital camera apparatus, in which the present invention is applied.

FIG. 2 is a block diagram showing a circuit configuration of AFE used in the digital camera apparatus shown in FIG. 1.

FIG. 3 is a block diagram showing functions that are realized by CPU used in the digital camera apparatus.

FIG. 4 is a view showing an pixel area of CCD used in the digital camera apparatus.

FIG. 5 is a timing chart indicating CCD driving signal in a draft mode.

FIG. 6 is a timing chart showing the CCD driving signal in AF mode.

FIG. 7 is a timing chart showing a CCD driving signal in a capture mode.

FIG. 8 is a flow chart of a process to be performed by CPU.

### DETAILED DESCRIPTION OF THE PREFERRED EMBODIMENTS

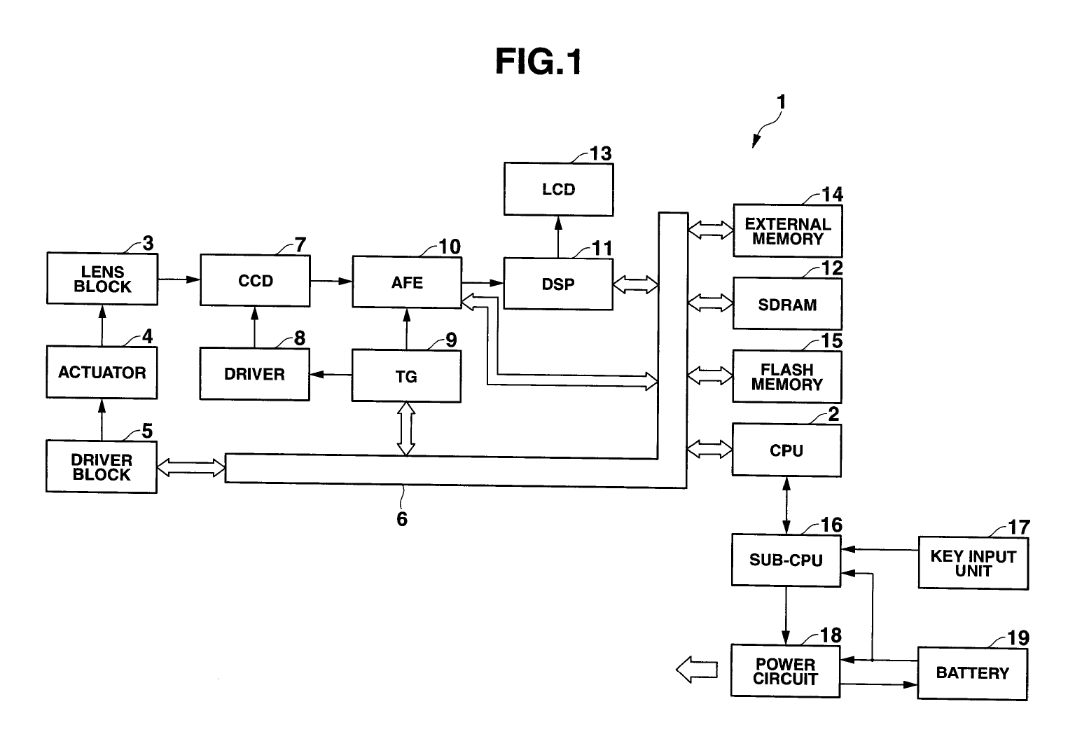

Now, preferred embodiments of a digital camera apparatus, to which the present invention is applied will be described with reference to the accompanying drawings in detail. FIG. 1 is a block diagram of a hardware configuration of the digital camera apparatus 1.

The whole system of the digital camera apparatus 1 is controlled by CPU (Central Processing Unit) 2. The digital camera apparatus 1 has a lens block 3, an actuator 4, and a driver block 5. The lens block 3, actuator 4, and driver block 5 are connected with each other through a bus 6. The lens block 3 has an optical system including a focus lens and a mechanical shutter. The actuator 4 has motors for driving the optical system and mechanical shutter, and the driver block 5 has various drivers for driving the actuator 4.

The digital camera apparatus 1 is provided with a solid state image pick-up device 7 such as CCD (Charge Coupled Device), for shooting an object. CCD 7 is a well-known solid state image pick-up device of a charge transfer type. CCD 7 is composed of a number of photo-diodes (picture elements) (not shown), which are disposed in the horizontal and vertical direction, and plural lines of vertical transfer CCD (not shown), which are disposed adjacently to each column of the photo diodes, and one line of horizontal transfer CCD (not shown), which is disposed adjacently to the last row of vertical transfer CCD.

A timing generator (TG) 9 generates a vertical CCD drive timing signal, a horizontal CCD drive timing signal, and an electronic shutter timing signal. A driver 8 generates CCD driving signals based on the vertical CCD drive timing signal, horizontal CCD drive timing signal, and electronic shutter timing signal generated by TG 9. The driver 8 supplies CCD driving signal to CCD 7 to drive the same.

TG 9 generates a drive timing signal in accordance with a driving mode set by CPU 2, wherein the drive timing signal consists of the vertical CCD drive timing signal, horizontal CCD drive timing signal, and electronic shutter timing signal. There are prepared three driving modes for CCD 7 such as a draft mode, AF mode, and capture mode. TG 9 has a register therein, which registers setting values each indicating the driving mode of CCD 7. When a setting value is set by CPU 2, TG 9 generates the drive timing signal (vertical CCD drive timing signal, horizontal CCD drive timing signal, electronic shutter timing signal) corresponding to the setting value (driving mode).

Driven by the driver 8, CCD 7 photoelectric-converts an optical image of an object focused on the optical system of the lens block 3 into an analog image signal representing the object, and supplies the analog image signal to AFE 10.

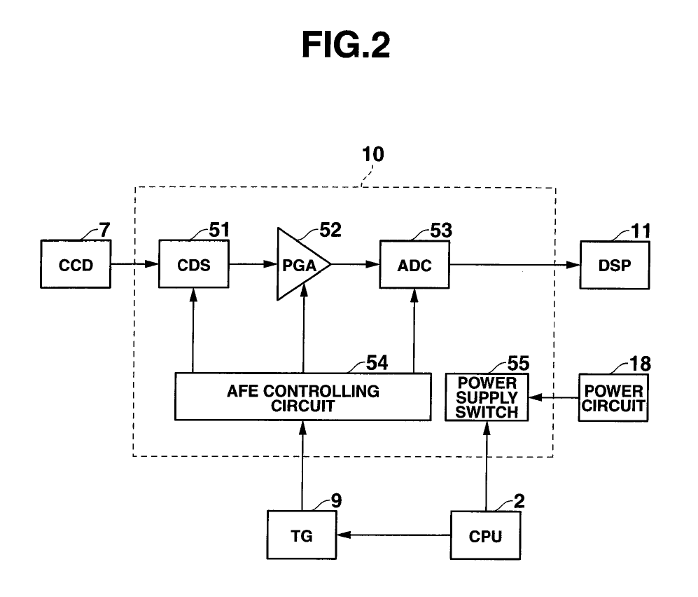

FIG. 2 is a block diagram showing a circuit configuration of AFE 10. AFE 10 comprises CDS 51, PGA 52, ADC (A-D Converter) 53, AFE controlling circuit 54 and a power supply switch 55, and functions as a signal processing unit.

CDS (Correlated Double Sampling circuit) 51 uses a correlated double sampling technique to reduce noises involved in the analog image signal supplied from the CCD 7, and supplies the image signal with noises reduced to PGA 52. PGA 52 amplifies and supplies the image signal to ADC 53. ADC 53 converts the image signal into a digital image signal and supplies the digital image signal to DSP (Digital Signal Processor) 11. A series of signal processes including the noise reduction in the image signal by CDS 51, amplification of the image signal by PGA 52, and digital signal conversion by ADC 53 are involved in the analog signal process by AFE 10.

AFE controlling circuit 54 receives AFE driving signal from TG 9. AFE driving signal is used to define a timing of the analog signal process in AFE 10. At a timing indicated by AEF driving signal, AFE controlling circuit 54 controls drive of analog circuits in CDS 51, PGA 52 and ADC 53. In accordance with a drive start signal and a drive stop signal supplied from CPU 2, the power supply switch 55 effects an on/off control of a driving current to be supplied from a power circuit 18 to the above analog circuits. The drive current supplied to the analog circuits is to drive the analog circuits.

DSP 11 executes a pedestal clumping process on the image signal supplied from AFE 10, converting the image signal to RGB data, and further converts RGB data to YUV data including a luminance component (Y) and color difference components (UV). DSP 11 executes a digital signal process on YUV data and stores the data in SDRAM 12, wherein the digital signal process includes processes for improving image quality, such as an auto white balance, contour enhancement, and pixel interpolation.

In a recording mode, YUV data is sent to LCD (Liquid Crystal Display monitor) 13, whereby one frame of image is displayed live on LCD 13, every time one frame of YUV data (one frame of image data) is stored in SDRAM 12. At the time when a shutter key has been pressed to shoot an object, CPU 2 compresses YUV data temporarily stored in SDRAM 12 and records in an external memory 14 the compressed data as an image file of a predetermined format. The external memory 14 is a memory card (not shown) detachably mounted on a camera body through a card interface (not shown).

In a reproducing mode, the image file recorded in the external memory 14 is read and expanded in response to a selecting operation by a user, and then is expanded over SDRAM 12 as YUV data, whereby YUV data is displayed on the LCD 13.

A flash memory 15 is a program storing memory that stores plural sorts of programs and data used by CPU 2 to control whole operation of the digital camera. The program stored in the flash memory 15 includes AF (auto focus) control program for performing a well-known contrast detecting method of automatically moving the optical system of the lens block 3 to a position to focus on an object.

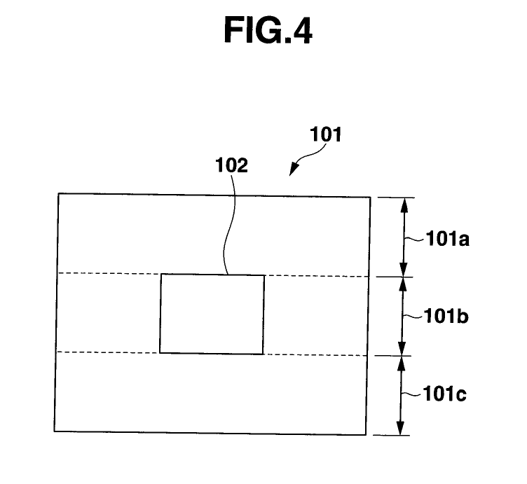

AF controlling operation by CPU 2 is of a center weighted focusing type, and brings the optical system of the lens block 3 to focus on an object at a central portion in a field angle. In AF controlling operation, CPU 2 successively detects contrast in image data corresponding to a predetermined central portion 102 (FIG. 4) of an effective pixel area 101 of CCD 7, while moving the optical system of the lens block 3, and moves the optical system of the lens block 3 to a position (focus position), at which the detected contrast becomes maximum.

Meanwhile, CPU 2 is connected with a sub-CPU 16. Further, the sub-CPU 16 is connected with a key input unit 17 and a power circuit 18. The key input unit 17 comprises various switches including a power button, a shutter key for instructing a shooting operation, a zoom operating button and a mode switching button. The shutter key in the key input unit 17 has a so-called half press shutter function, which allows a half-way press shutter operation and a full-way press shutter operation. In the recording mode, the half-way press shutter operation triggers AF controlling operation by CPU 2.

The sub-CPU 16 periodically scans operated states of the various switches of the key input unit 17, and sends CPU 2 an operation signal corresponding to the operated state of the switch by the user. The power circuit 18 uses a battery 19 installed in the camera body as a power source to generate the standard voltage for the digital camera apparatus 1, and generates voltages necessary for the above various units.

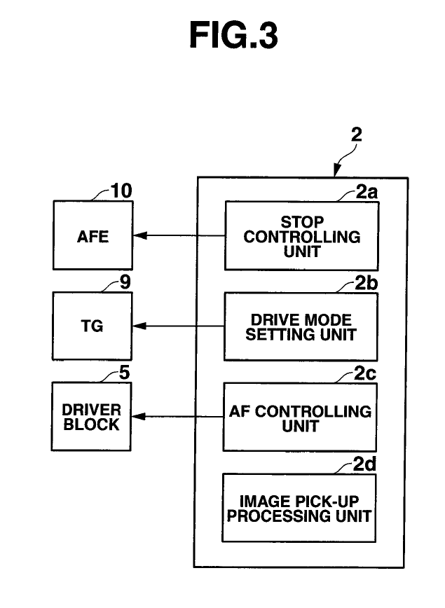

FIG. 3 is a block diagram showing functions that CPU 2 realizes by running the program stored in the flash memory 15 in the recording mode set in the digital camera apparatus 1. In the recording mode, CPU 2 functions as a stop controlling unit 2a, drive mode setting unit 2b, AF controlling unit 2c, and image pick-up processing unit 2d. In the recording mode, the stop controlling unit 2a ceases operation of AFE 10 as needed. The drive mode setting unit 2b sets the driving mode of CCD 7 in response to operation of the digital camera apparatus 1, and makes TG 9 generate a drive timing signal corresponding to the set drive mode. AF controlling unit 2c controls the driver block 5 to move the optical system of the lens block 3. Further, the image pick-up processing unit 2d controls operation of the digital camera apparatus 1 other than those described above.

The driving mode of CCD 7 will be described. As described above, there are prepared three modes for the driving mode of CCD 7, that is, the draft mode, AF mode, and capture mode.

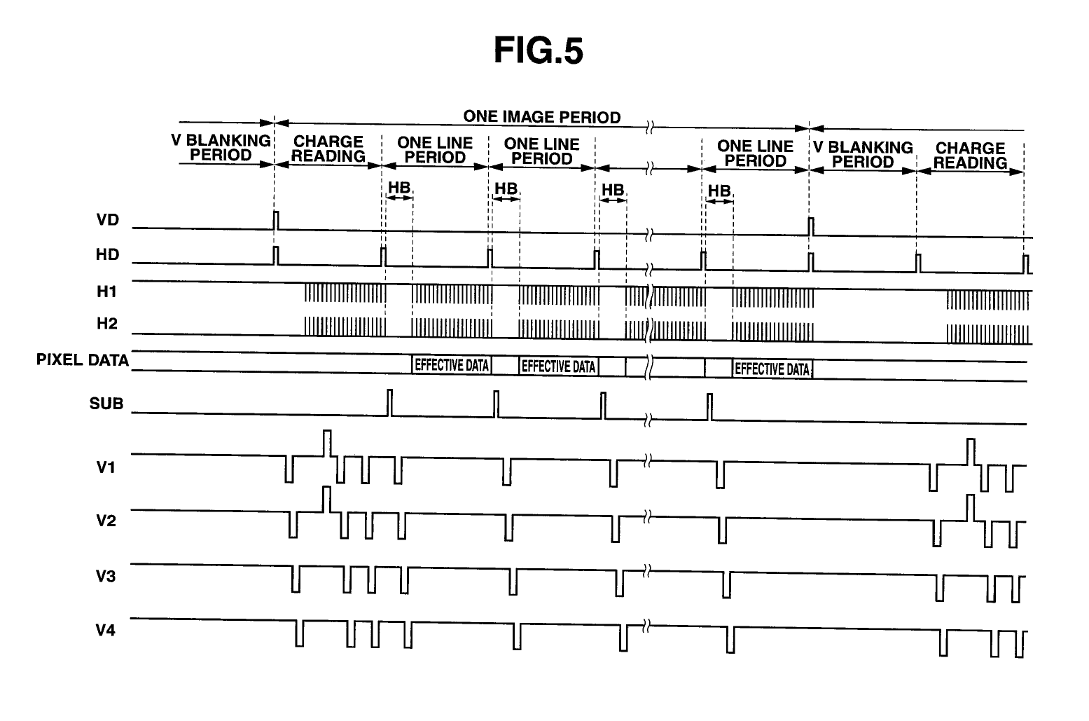

The draft mode is set while a live image is displayed on the liquid crystal displaying monitor 13. FIG. 5 is a timing chart indicating CCD driving signal output from the driver 8 in the draft mode. A vertical synchronizing signal VD is a timing signal of one image period, that is, a signal indicating a start timing of reading one frame of charge accumulated in CCD 7. A horizontal synchronizing signal HD is a timing signal of one line period, that is, a signal indicating a start timing of reading one line of charge accumulated in CCD 7. The “one line” means a series of photodiodes (pixels) disposed in the horizontal direction in the photodiodes (pixels) disposed in the vertical and horizontal direction in CCD 7.

As shown in FIG. 5, the driver 8 outputs 4 phases of vertical CCD driving pulses, V1, V2, V3, and V4, which correspond to the number of electrodes (four electrodes) for applying voltages for the vertical transfer of charge, 2 phases of horizontal CCD driving pulses, H1 and H2, which correspond to the number of electrodes (two electrodes) for applying voltages for the horizontal transfer of charge, and electronic shutter pulses SUB within one output interval, that is, one image period of the vertical synchronizing signal VD.

Charge of each pixel accumulated in a photodiode of CCD 7 is transferred to the vertical transfer CCD in a charge reading period (Refer to FIG. 5) immediately after the rising of the vertical synchronizing signal VD within one image period. Further, every output interval, that is, one line period of the horizontal synchronizing signal HD, charge for each line transferred to the vertical transfer CCD is vertical-transferred to the horizontal transfer CCD in sequence in response to the vertical CCD driving pulses V1 to V4, whereby charge for one line is transferred to the horizontal transfer CCD. The charge of one line transferred to the horizontal transfer CCD is output in sequence from CCD 7 in synchronization with the horizontal CCD driving pulses H1, H2. The driver 8 stops an output operation of the horizontal CCD driving pulses H1, H2 during an output operation of the vertical CCD driving pulses V1 to V4. The period is called “H blanking period” (“HB” in FIG. 5), in which the driver 8 stops the output operation of the horizontal CCD driving pulses H1, H2.

In one image period, charge of all the pixels (one frame) in CCD 7 is output as an image signal. In other words, a live image is produced from pixel data, that is, a live image is produced from accumulated charge of plural lines (effective data in FIG. 5). One image period is set longer than a period which is required by CCD 7 to output the charge accumulated in all the pixels. When the accumulated charge of whole image has been output, ineffective accumulated charge is output from CCD 7. In general, the period (“V blanking period” in FIG. 5), in which the ineffective accumulated charge is output is called “V blanking period”.

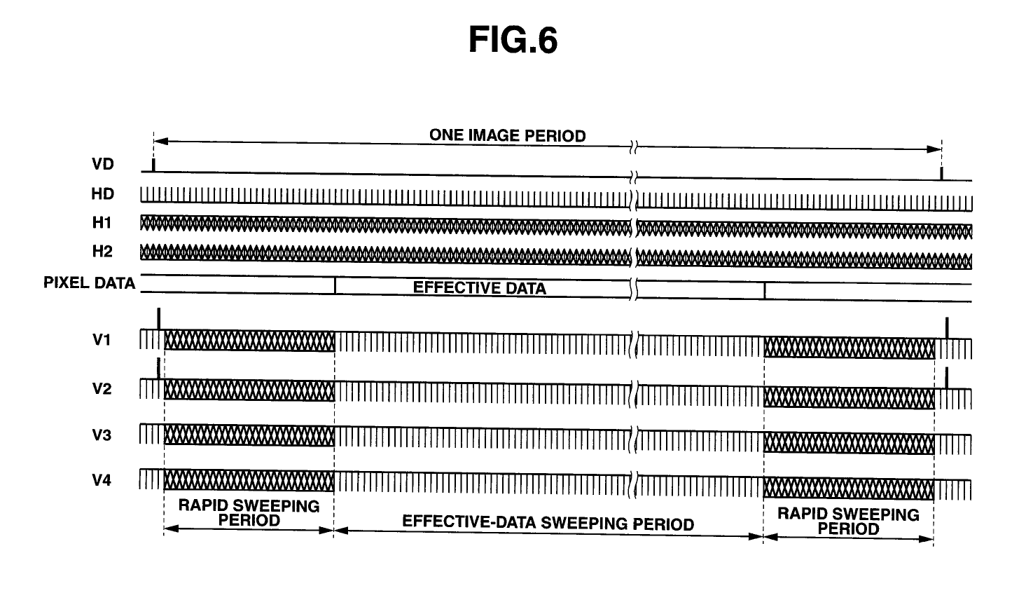

AF mode described above is an AF controlling period, in which CPU 2 performs AF controlling operation, and more specifically, AF mode is a drive mode, which is set during a period, in which the optical system of lens block 3 moves to the focus position, immediately after the user presses the shutter key halfway. FIG. 6 is a timing chart indicating the CCD driving signal output within one image period, in which the driver 8 drive's CCD 7 in AF mode.

As described above, since AF controlling operation by CPU 2 is of the contrast detecting system and uses the center weighted focusing technique, only the pixel data at the central portion of an image to be shot is used in AF controlling operation, and pixel data at a portion other than the central portion is not used in AF controlling operation. Therefore, in one image period in AF mode, the driver 8 discharges or sweeps out charge accumulated in the photodiodes disposed in a top pixel portion 101a on the upper side of a central portion 102 and charge accumulated in the photodiodes disposed in a bottom pixel portion 101c on the downside of the central portion 102 in an effective pixel area 101 (Refer to FIG. 4), and outputs from CCD 7 only the charge accumulated in the photodiodes disposed in an intermediate portion 101b between the top pixel portion 101a and the bottom pixel portion 101c, wherein the intermediate portion 101b includes the central portion 102.

In one image period in AF mode, the driver 8 performs a rapid sweeping drive, wherein the vertical CCD driving pulses V1 to V4 and the horizontal CCD driving pulses H1, H2 are output simultaneously within a line period of plural lines, in which the charge accumulated in photodiodes disposed in the top pixel area 101a and bottom pixel area 101c of the effective pixel area 101 is read. In other words, after transferring the charge accumulated in plural lines of photodiodes disposed respectively in the top pixel area 101a and bottom pixel area 101c to the vertical transfer CCD, the driver 8 vertical-transfers the charge accumulated in the vertical transfer CCD to the horizontal transfer CCD at once. Further, the driver 8 horizontal-transfers plural lines of charge accumulated in the horizontal transfer CCD, thereby discharging the charge accumulated in the horizontal transfer CCD at once.

The period, in which the driver 8 performs the rapid sweeping drive is a rapid sweeping period shown in FIG. 6. The rapid sweeping period is the period, in which the charge accumulated in the photodiodes disposed in the top pixel portion 101a and the bottom pixel portion 101c in the effective pixel area 101 of CCD 7 is discharged more rapidly than the charge accumulated in the photodiodes in the intermediate pixel portion 101b is discharged, wherein the former charge is not used as pixel information in AF controlling operation but the latter charge is used as the pixel information in AF controlling operation.

In a line period of plural lines corresponding to the intermediate pixel portion 101b of the effective pixel area 101 in CCD 7, excluding a rapid sweeping period, as shown in FIG. 4, that is, in an effective-data sweeping period shown in FIG. 6, the driver 8 outputs the vertical CCD driving pulses V1 to V4, and the horizontal CCD driving pulses H1, H2 substantially in the same manner as in the draft mode. After vertical-transferring line by line to the horizontal transfer CCD the accumulated charge of plural continuous lines in the intermediate pixel area 101b of the effective pixel area 101 of CCD 7, that is, the charge of pixels used as pixel information in a focus controlling operation, the driver 8 horizontal-transfers every line of charge accumulated in the horizontal transfer CCD, discharging the charge in the horizontal transfer CCD.

In AF controlling period, CPU 2 executes AF controlling operation based on pixel data of accumulated charge of plural lines adjacent in the intermediate pixel area 101b of the effective pixel area 101 in CCD 7, that is, based only on the effective data shown in FIG. 6.

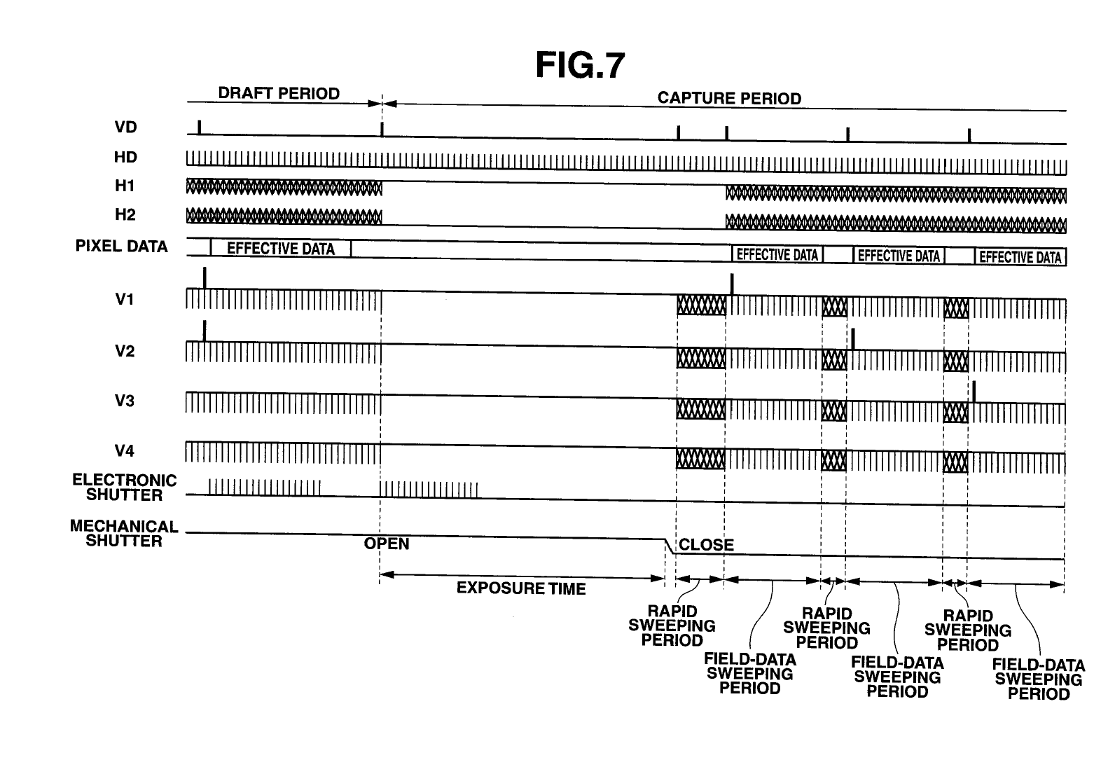

The capture mode is the drive mode, which is set during a period, in which the charge accumulated in all the photodiodes in CCD 7 is discharged within an exposure time, immediately after the user presses the shutter key full-way. FIG. 7 is a timing chart indicating CCD driving signal output from the driver 8 in the capture mode.

CCD driving signal in the capture mode (FIG. 7) is different from CCD driving signal in the draft mode (FIG. 5) in the following points. In the capture mode, the driver 8 does not output the vertical CCD driving pulses V1 to V4 and horizontal CCD driving pulses H1, H2, since the mechanical shutter is used in the exposure time.

After the exposure time has lapsed, the driver 8 outputs the vertical CCD driving pulses V1 to V4 and horizontal CCD driving pulses H1, H2, thereby allowing the horizontal transfer CCD to discharge the charge of all the pixels (plural lines) accumulated in the photodiodes during the exposure time field by field.

One field of analog signal (image signal) consists of pixel charge corresponding to plural lines disposed every n-line interval in CCD 7. For example, in the case of n=3, on the assumption that the line adjacent to the horizontal transfer CCD is the first line, the first field consists of the first line, fourth line, seventh line, and so on, and the second field consists of the second line, fifth line, eight lines, and so on, and third field consists of third line, sixth line, ninth line, and so on.

The above example will be described more specifically. The driver 8 transfers charge accumulated in the photodiodes disposed in plural lines (the first, fourth, seventh line, and so on) of the first field to the vertical transfer CCD, and further vertical-transfers each line of charge transferred to the vertical transfer CCD to the horizontal transfer CCD in sequence, and then the driver 8 horizontal-transfers the charge from the horizontal transfer CCD line by line, thereby discharging all the charge from the horizontal transfer CCD. Then, the driver 8 transfers the charge accumulated in plural lines (the second, fifth, eighth line, and so on) in the second field to the horizontal transfer CCD and then discharges the charge from the horizontal transfer CCD in sequence substantially in the same manner. Further, the driver 8 transfers the charge accumulated in plural lines (the third, sixth, ninth line, and so on) in the third field to the horizontal transfer CCD and then discharges the charge from the horizontal transfer CCD in sequence substantially in the same manner.

In the above example, the driver 8 repeatedly performs three times a field-charge transfer operation of a line period corresponding to plural lines, thereby discharging the charge of all the pixels from the horizontal transfer CCD. Field sweeping periods shown in FIG. 7 are periods, in which the accumulated charge of respective fields is discharged.

In the capture mode, there are rapid sweeping periods between the exposure time and the field sweeping period of the first field, and thereafter, among the field sweeping periods. The driver 8 performs the rapid sweeping drive in each rapid sweeping period, outputting the vertical CCD driving pulses V1 to V4 and the horizontal CCD driving pulses H1, H2 simultaneously.

The rapid sweeping drive in the capture mode is different from the rapid sweeping drive in AF mode shown in FIG. 6 in the following points. In the rapid sweeping drive in the capture mode, having transferred the charge accumulated in all the vertical transfer CCD to the horizontal transfer CCD at once, the river 8 horizontal-transfers at once the charge of the all the lines stored in the horizontal transfer CCD, discharging all the charge in the horizontal transfer CCD. The charge of all the lines accumulated in the vertical transfer CCD is charge which is accumulated in the vertical transfer CCD as time goes by, and called a dark current, casing a fixed pattern noise.

In the rapid sweeping period in the capture mode differently in AF mode, the charge accumulated in the vertical transfer CCD, that is, false pixel charge (dark current) which is not used as pixel information is discharged more rapidly in the rapid sweeping drive than the charge which is accumulated in the photodiodes to be used as pixel information.

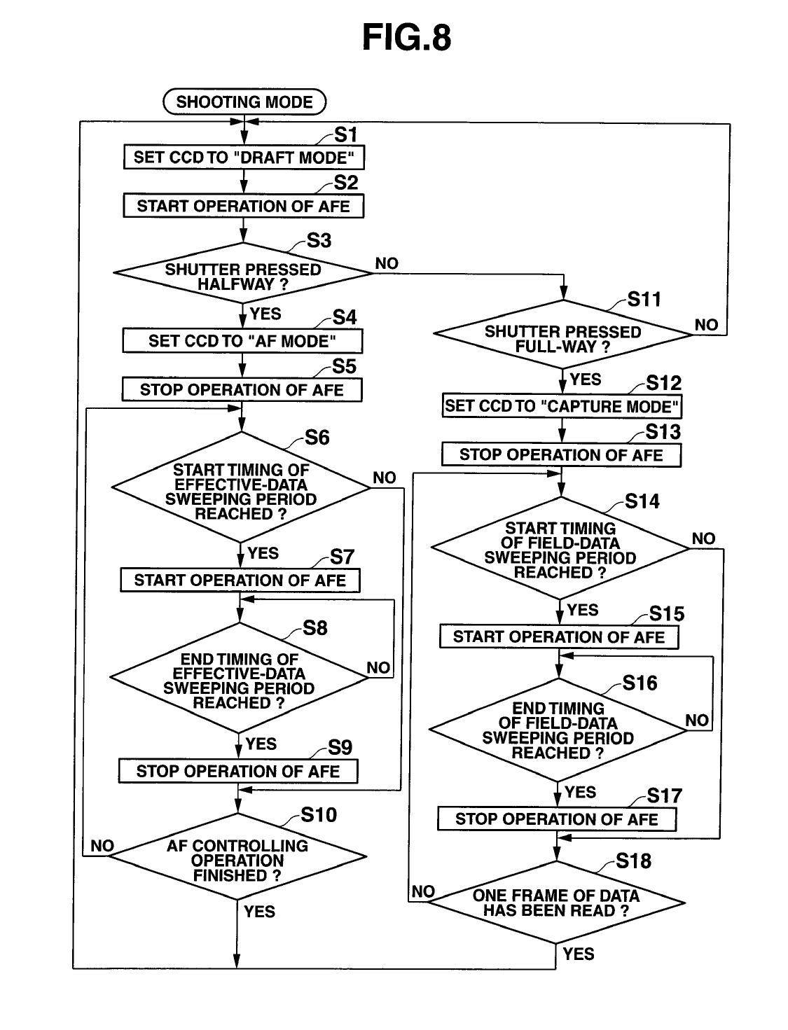

As shown in FIG. 3, CPU 2 serves as the stop controlling unit 2a, drive mode setting unit 2b, AF controlling unit 2c, and image pick-up processing unit 2d, in the recording mode. A process performed by CPU 2 in the recording mode will be described with reference to a flow chart of FIG. 8.

In the recording mode, the image pick-up processing unit 2d sets the drive mode of CCD 7 to draft mode at step S1. In other words, the image pick-up processing unit 2d makes TG 9 generate a drive timing signal corresponding to the draft mode, and makes the driver 8 start the driving operation in the draft mode of CCD 7 shown in FIG. 5.

Further, the image pick-up processing unit 2d brings AFE 10 into an operating state at step S2. In other words, the image pick-up processing unit 2d makes CDS 51, PGA 52 and ADC 53 perform the analog signal processing operation. In the analog signal processing at step S2, the image pick-up processing unit 2d makes TG 9 generate and supply AFE driving signal to AFE controlling circuit 54. Meanwhile, the image pick-up processing unit 2d sends a drive starting signal to the power supply switch 55, thereby supplying a driving current to the analog circuits such as CDS 51, PGA 52 and ADC 53.

The image pick-up processing unit 2d judges at step S3 whether or not the shutter key has been pressed halfway by the user, and judges at step S11 whether or not the shutter key has been pressed full-way by the user. When the shutter key has not been pressed halfway (NO at step S3) and also the shutter key has not been pressed full-way (NO at step S11), then CCD 5 is driven in the draft mode.

When the image pick-up processing unit 2d determines at step S3 that the shutter key has been pressed halfway by the user (YES at, step S3) while CCD 7 is driven in the draft mode, the drive mode setting unit 2b sets the drive mode of CCD 7 to AF mode at step S4. In other words, the drive mode setting unit 2b makes TG 9 generate a drive timing signal corresponding to AF mode, and makes the driver 8 start the driving operation in AF mode of CCD 7 shown in FIG. 6.

Meanwhile, the stop controlling unit 2a brings AFE 10 once into a halt state at step S5. While AFE 10 is in a halt state, CDS 51, PGA 52 and ADC 53 stop performing the analog signal processing operation. In the process at step S5, the stop controlling unit 2a stops TG 9 from generating AFE driving signal, and sends the power supply switch 55 a drive stopping signal, thereby stopping supplying a driving current to the analog circuits such as CDS 51, PGA 52 and ADC 53. Although not shown in FIG. 8, the image pick-up processing unit 2d starts AF controlling operation.

While CCD 7 is driven in AF mode, the image pick-up processing unit 2d holds AFE 10 in the halt state before the start timing of the effective-data sweeping period is reached in either one of the above image periods, in other words, within the rapid sweeping period (NO at step S6). When the start timing of the effective-data sweeping period has been reached (YES at step S6), the image pick-up processing unit 2d brings AFE 10 into an operating state in synchronization with the start timing of the effective-data sweeping period at step S7. The process at step S7 is substantially the same as the process at step S2.

The image pick-up processing unit 2d brings AFE 10 from its halt state into the operating state not at the start timing of the effective-data sweeping period but just before such start timing. This is because the analog circuits in AEF 10 need a certain period of time before operation of said circuits is brought into a steady state.

Thereafter, the image pick-up processing unit 2d holds AFE 10 in the operating state before the end timing of the effective-data sweeping period, that is, the start timing of the rapid sweeping period is reached (NO at step S8). When the end timing of the effective-data sweeping period, or the start timing of the rapid sweeping period has been reached (YES at step S8), the stop controlling unit 2a brings the AFE 10 into the halt state again in synchronization with the end timing of the effective-data sweeping period at step S9. The process at step S9 is substantially the same as the process at step S5.

While AF controlling operation is not finished (NO at step S10), CPU 2 returns to step S6, and repeatedly performs the processes at steps S6 to S9. When AF controlling operation has been finished (YES at step S10), CPU 2 returns to step S1, where the image pick-up processing unit 2d sets the drive mode of CCD 7 to the draft mode again. The image pick-up processing unit 2d brings AFE 10 into the operating state again at step S2.

When the image pick-up processing unit 2d determines at step S11 that the shutter key has been pressed full-way while CCD 7 is driven in the draft mode (NO at step S3 and YES at step S11), the drive mode setting unit 2b sets the drive mode of CCD 7 to the capture mode at step S12. In other words, the drive mode setting unit 2b makes TG9 generate a drive timing signal corresponding to the capture mode, and makes driver 8 start driving operation in the capture mode of CCD 7 shown in FIG. 7.

Then, the stop controlling unit 2a brings the AFE 10 once into the halt state again at step S13. The process at step S13 is substantially the same as the process at step S5 or S9. Although not shown in FIG. 8, the image pick-up processing unit 2d starts counting the exposure time of CCD 7 while the processes are being performed at steps S12 and S13.

While CCD 7 is driven in the capture mode, the image pick-up processing unit 2d holds the AFE 10 in the halt state before the first field-data sweeping period has been reached, in other words, in a period including the exposure time and the rapid sweeping period. When the start timing of the field-data sweeping period has been reached (YES at step S14), the stop controlling unit 2a brings AFE 10 into the operating state in synchronization with the start timing of the field-data sweeping period at step S15. The process at step S15 is substantially the same as the process at step S2 or S7.

The image pick-up processing unit 2d holds AFE 10 in the operating state before the end timing of field-data sweeping period, or the start timing of the second rapid sweeping period is reached (NO at step S16). When the end timing of field-data sweeping period, or the start timing of the second rapid sweeping period has been reached (YES at step S16), the stop controlling unit 2a brings AFE 10 into the halt state in synchronization with the end timing of the field-data sweeping period at step S17. The process at step S17 is substantially the same as the process at step S5, S9, or S13.

Until an analog signal (image signal) of one frame has been read from CCD 7 (NO at step S18), the processes at steps S14 to S17 are repeatedly performed. When all the frame data has been read (YES at step S18), CPU 2 returns to step S1, where the image pick-up processing unit 2d sets the drive mode of CCD 7 to the draft mode, and then the image pick-up processing unit 2d brings AFE 10 into the operating state again at step S2.

While the digital camera apparatus 1 is set to the recording mode, the image pick-up processing unit 2d repeatedly performs the process at step S3 and the processes at the following steps every time it is detected that the user has pressed the shutter key halfway or full-way.

As described above, in the recording mode of the digital camera apparatus 1, while CCD 7 is driven in the AF mode and/or in the capture mode, CPU 2 keeps the analog signal process of AFE 10 in the halt state during the rapid sweeping period in each drive mode of CCD 7. In other words, in AF mode CPU 2 stops AFE 10 from performing the analog signal process in the rapid sweeping drive period, in which charge of predetermined pixels is rapidly discharged from CCD 7, wherein the charge is not used as pixel information in AF controlling operation. Meanwhile, in the capture mode CPU 2 stops AFE 10 from performing the analog signal process in the rapid sweeping drive period, in which charge of false pixels (dark current) accumulated in the vertical transfer CCD is rapidly discharged from CCD 7, wherein the charge is not used as pixel information. While CCD 7 is driven in the capture mode, CPU 2 stops AFE 10 from performing the analog signal process in the exposure time.

In the digital camera apparatus 1 according to the present embodiment, power can be reduced, which is consumed by operation of AFE 10 during the rapid sweeping period in the recording mode, that is, consumed by the analog signal process to be performed by AFE 10 on the analog signal or charge of predetermined pixels, which is not used as pixel information. Therefore, power consumption during the shooting operation is more reduced in the present digital camera apparatus 1 compared with conventional shooting operation. The charge of predetermined pixels which is not used as pixel information is charge which is output from CCD 7 as an analog signal and does not contribute to represent an object.

In the digital camera apparatus 1 according to the present embodiment, while AFE 10 is held in the halt state during the rapid sweeping period, all of the analog circuits such as CDS 51, PGA 52 and ADC 53 are brought into the halt state. But a modification may be made to the embodiment of the digital camera apparatus 1 such that either one or two of the analog circuits CDS 51, PGA 52 and ADC 53 is brought into the halt state. In other words, even if an arrangement is made such that at least one of the analog circuits CDS 51, PGA 52 and ADC 53 is brought into the halt state, such arrangement can reduce more power consumption during the shooting operation compared with the conventional shooting operation.

In the digital camera apparatus 1 according to the present embodiment, to stop operation of the analog circuits of AFE 10, CPU 2 stops TG 9 from generating AFE driving signal to be supplied to AFE 10, and also stops supplying the driving current to the analog circuits of AFE 10. But to stop operation of the analog circuits of AFE 10, a modification may be made such that either CPU 2 stops TG 9 from generating AFE driving signal to be supplied to AFE 10, or CPU 2 stops supplying the driving current to the analog circuits of AFE 10.

The embodiment has been described, in which AF controlling operation of CPU 2 employs the center weighted focusing technique, which brings the optical system of the lens block 3 to focus on the object based only on image information (contrast) of the central portion of the object to be shot. But a modification may be made to the center weighted focusing technique of AF controlling operation, such that brings the optical system of the lens block 3 to focus on the object based on image information (contrast) of a portion other than the central portion of the object to be shot. In the modification that brings the optical system of the lens block 3 to focus on the object based on image information of a portion other than the central portion of the object to be shot, it is necessary to make the driver 8 perform the rapid sweeping drive in the driving period corresponding to such portion other than the central portion of the object to be shot, while CCD 7 is driven in AF mode.

When the digital camera apparatus 1 is set to the recording mode, an arrangement is possible which brings AFE 10 into the operating state during the rapid seeping period, only when the drive mode of CCD 7 is set to AF mode or the capture mode. The arrangement that brings AFE 10 into the operating state during the rapid seeping period in AF mode or the capture mode can reduce more power consumption compared with conventional technique.

The stop controlling unit 2a, whose function is realized by CPU 2 in the present embodiment can be realized by a hardware configuration as necessary.

What is claimed is:

1. A digital camera apparatus comprising:
a solid state image pick-up device for photoelectric-converting an optical image of an object into an analog signal representing an object image of the object;
a signal processing unit for performing an analog signal process on the analog signal converted by the solid state image pick-up device; and
a stop controlling unit for stopping the signal processing unit from performing the analog signal process on the analog signal which is composed of predetermined charge that is not used as pixel information, during a rapid sweeping period, in which the analog signal which is composed of the predetermined charge that is not used as pixel information, is discharged more rapidly from the solid state image pick-up device than the analog signal which is composed of charge that is used as pixel information.

2. The digital camera apparatus according to claim 1, wherein
the stop controlling unit stops supplying power to the signal processing unit for performing the analog signal process on the analog signal output from the solid state image pick-up device, thereby stopping the signal processing unit from performing the analog signal process on the analog signal which is composed of the predetermined charge that is not used as pixel information.

3. The digital camera apparatus according to claim 1, further comprising:
a drive mode setting unit for setting a drive mode of the solid state image pick-up device to one of plural previously prepared drive modes, wherein
the stop controlling unit stops the signal processing unit from performing the analog signal process on the analog signal which is composed of the predetermined charge that is not used as pixel information, during the rapid sweeping period in which a predetermined drive mode is set to the solid state image pick-up device by the drive mode setting unit.

4. The digital camera apparatus according to claim 1, wherein
the predetermined charge that is not used as pixel information is charge of pixels disposed in a pixel area specified in whole pixel area of the solid state image pick-up device.

5. The digital camera apparatus according to claim 1, wherein
the solid state image pick-up device is of a charge transfer type, and
the predetermined charge that is not used as pixel information is charge which causes a dark current and is accumulated in a pixel charge transferring pass as time goes by.

6. The digital camera apparatus according to claim 1, further comprising:
a focus controlling unit for performing an focus controlling process to focus on the object based on image information consisting of a signal which has been subjected to the analog signal process by the signal processing unit, wherein
the stop controlling unit stops the signal processing unit from performing the analog signal process on the analog signal which is composed of the predetermined charge that is not used as pixel information, during the rapid sweeping period in which the focus controlling process is performed by the focus controlling unit.

7. The digital camera apparatus according to claim 6, wherein
the predetermined charge that is not used as pixel information is charge of pixels disposed in a pixel area specified in whole pixel area of the solid state image pick-up device, which charge is not used as pixel information in the focus controlling process by the focus controlling unit.

8. The digital camera apparatus according to claim 1, wherein
the stop controlling unit stops the signal processing unit from performing the analog signal process on the analog signal which is composed of the predetermined charge that is not used as pixel information, during the rapid sweeping period in a period of a shooting operation by the solid state image pick-up device to obtain the object image to be recorded.

9. A computer readable recording medium to be mounted on a digital camera apparatus, wherein the digital camera apparatus is provided with a computer, a solid state image pick-up device for photoelectric-converting an optical image of an object into an analog signal representing an object image of the object, and a signal processing unit for performing an analog signal process on the analog signal converted by the solid state image pick-up device, the recording medium having recorded thereon a computer program when executed to make the computer function as a stop controlling unit for stopping the signal processing unit from performing the analog signal process on the analog signal which is composed of predetermined charge that is not used as pixel information, during a rapid sweeping period, in which the analog signal which is composed of the predetermined charge that is not used as pixel information, is discharged more rapidly from the solid state image pick-up device than the analog signal which is composed of charge that is used as pixel information.
